(19) United States
(12) Patent Application Publication
(10) Pub. No.: US 2021/0149678 A1
(43) Pub. Date: May 20, 2021

(54) Fault-Tolerant Execution of Command Pipeline Steps

(71) Applicant: Shoreline Software, Inc., Redwood City, CA (US)

(72) Inventors: Anurag Gupta, Atherton, CA (US); Charles Ian Ormsby Cary, Redwood City, CA (US)

(21) Appl. No.: 16/684,001

(22) Filed: Nov. 14, 2019

(51) Int. Cl. G06F 9/38; G06F 9/30; G06F 16/23

(52) U.S. Cl. CPC G06F 9/3869; G06F 16/2379; G06F 9/30018

(57) ABSTRACT

Described are systems and methods for a fault-tolerant execution of command pipeline steps. An example method can commence with receiving a request from a customer. The request can include one or more pipeline steps. The method can further include creating an execution plan for the request based on the one or more pipeline steps. After the execution plan is created, the method can continue with ascertaining resources available to the customer for the execution plan. The method can then proceed with managing execution of the execution plan through agents associated with the resources. The method can terminate with providing results of the execution to the customer.

### TECHNICAL FIELD

The present technology relates generally to distributed execution of requests, and more particularly, but not by limitation, to fault-tolerant execution of command pipeline steps.

### BACKGROUND

Customers of network systems and services expect their systems to be running and perform consistently. Jitter, downtime, and even maintenance windows in performance are no longer acceptable. Customers run their systems around the clock and expect them to run without any interruptions or performance loss.

Additionally, network environments are becoming more complex. Currently, an individual operator is responsible for multiple machines, required to understand many different services, be fluent with both multiple cloud and on-premises environments, and operate in a rapidly changing environment. Existing tools are inadequate for ever increasing network and server administration needs. For example, existing tools for monitoring and ticket administration require a human to review dashboards and manually process ticket queues, even for repetitive issues.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one embodiment of the disclosure, a method for a fault-tolerant execution of command pipeline steps is provided. The method may commence with receiving a request from a customer. The request may include one or more pipeline steps. The method may further include creating an execution plan for the request based on the one or more pipeline steps. The method may continue with ascertaining resources available to the customer for the execution plan. The method may further include managing execution of the execution plan through agents associated with the available resources. The method may terminate with providing results of the execution to the customer.

According to one example embodiment of the disclosure, a system for a fault-tolerant execution of command pipeline steps is provided. The system may include a front end module and a back end module communicatively coupled to each other. The front end module may be configured to receive a request from a customer. The request may include one or more pipeline steps. The back end module may be configured to process the request, authenticate the customer based on the request, and plan an execution of the request based on resources available to the customer. The back end module may be further configured to translate the request into one or more flows for parallel execution on the available resources. A plurality of agents can be deployed on the available resources. The back end module may manage the plurality of agents. The plurality of the agents may be configured to run the one or more flows. The back end module may provide results of the execution to the customer.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a high-level schematic diagram of an exemplary computing architecture of a computing environment for implementing systems and methods for a fault-tolerant execution of command pipeline steps.

FIG. 2 is a schematic diagram illustrating a process of measuring system performance and identifying errors, according to an example embodiment.

FIG. 3 is a block diagram illustrating a back end module of the system for a fault-tolerant execution of command pipeline steps, according to some embodiments.

FIG. 4 shows a planner and steps performed by the planner to provide a fault-tolerant execution of command pipeline steps, according to an example embodiment.

FIG. 5 shows a schematic diagram illustrating a logical execution graph and a physical execution graph, according to an example embodiment.

FIG. 6A shows steps performed to gather context associated with central processing units, according to an example embodiment

FIG. 6B shows steps performed by each of central processing units, according to an example embodiment.

FIG. 7 is a flow chart showing a method for a fault-tolerant execution of command pipeline steps, according to an example embodiment.

FIG. 8 is a schematic diagram of a computing system that is used to implement embodiments according to the present technology.

### DETAILED DESCRIPTION

The following detailed description of embodiments includes references to the accompanying drawings, which form a part of the detailed description. Approaches described in this section are not prior art to the claims and are not admitted prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The present disclosure is directed to various embodiments of systems and methods for a fault-tolerant execution of command pipeline steps. The systems and methods may allow automating control, provide quick reaction time, allow taking continuous actions and adjusting subsequent actions based on a feedback from the actions already taken, as well as allow taking proactive actions before a system is impaired and scaling operations to a fleet size. The disclosed systems and methods may free up and reduce fatigue of human operators resulting from performing tedious and repetitive tasks.

The system of the present disclosure can facilitate the process of creating automated remediations (a measure-alert-act loop). According to some embodiments, customers are able to define tasks they want to run. In an example embodiment, tasks can we written using native scripts such as Shell, Python, and so forth. A task can be defined for a simple pipelined execution as though it would be run on a single machine. The system can handle converting the script to one or more fleet-wide parallel, distributed, fault-tolerant, event-driven, scalable, secure, and automated flows. Once converted, the flows can be run across thousands or millions of managed resources. This approach can be used to monitor customer systems against desired behavior and take actions in response to detected anomalies. This approach can also allow handling various failures, missing network messages, out of order delivery, changing definitions, additions/removals of parts of the fleet, and so forth. This handling can be done proactively by preventing issues based on a rate of metric change in normal behavior before these issues arise.

An example method for a fault-tolerant execution of command pipeline steps can commence with receiving a request from a customer. The request may include one or more pipeline steps. The one or more pipeline steps can be used to create an execution plan for the request. Upon creation of the execution plan, resources available to the customer for the execution plan can be ascertained. The execution of the execution plan may be managed through agents associated with the available resources associated with the customer. Results of the execution can be then provided to the customer.

According to various example embodiments, an agent is a software that runs on a resource associated with the customer (e.g., a customer computer or a cloud resource), collectively referred to as agents. A subset of agents that can directly communicate with the system for a fault-tolerant execution of command pipeline steps is referred to herein as dispatchers. Only the agents that act as dispatchers can be allowed to communicate with the system for reasons such as security because the customers may not want to have all of their resources/nodes/computers to directly communicate with resources/nodes/computers outside of a data center/computing environment of the customers.

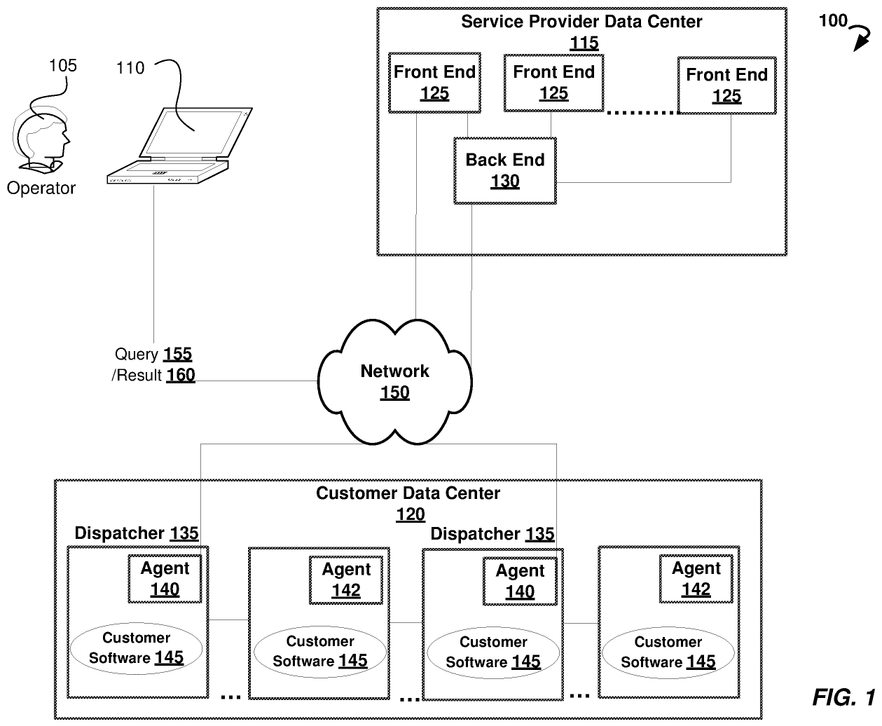

Referring now to the drawings, FIG. 1 is a high-level schematic diagram of an exemplary computing architecture (hereinafter referred to as architecture 100) of a computing environment for implementing systems and methods for a fault-tolerant execution of command pipeline steps. The architecture 100 can include an operator 105, a computing device 110 associated with the operator 105, a service provider data center 115, a customer data center 120, and a network 150. The service provider data center 115 may include a plurality of front ends 125 (including front end nodes) and a back end 130 (including back end nodes). In an example embodiment, the service provider data center 115 may act as a system for a fault-tolerant execution of command pipeline steps. In some embodiments, the system for a fault-tolerant execution of command pipeline steps may include a server or cloud-based computing device configured to specifically perform the operations described herein. The system for a fault-tolerant execution of command pipeline steps can also include a plurality of distributed computing systems that cooperatively provide the features of the system for a fault-tolerant execution of command pipeline steps. For example, individual systems of the plurality of distributed computing systems can provide one or more unique functions or services. In some embodiments, the system for a fault-tolerant execution of command pipeline steps can comprise a cloud computing environment or other similar networked computing system.

The customer data center 120 may include a plurality of agents 140 and 142. Some of agents, e.g., agents 140, may act as dispatchers 135 and communicate with the back end 130 of the service provider data center 115. Each of the computing device 110, the service provider data center 115, and the customer data center 120 may communicate with each other via the network 150.

The network 150 may include the Internet, a computing cloud, Representational State Transfer services cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, Ea or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Limited duplex paging network, Bluetooth radio, or an IEEE 802.11-based radio frequency network. The network 150 can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The network 150 may include a network of data processing nodes, also referred to as network nodes, that are interconnected for the purpose of data communication.

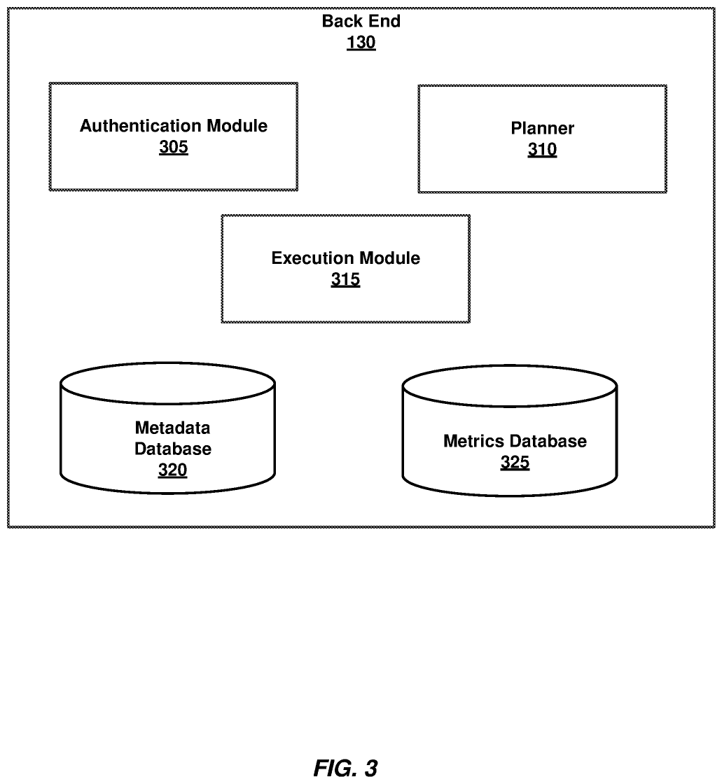

When the operator 105 sends a query 155, the query 155 may be received by one of front ends 125. The one of front ends 125 can provide the query 155 to the back end 130. The back end 130 may process the query 155 with a planner and a metadata database (as described in more detail below with reference to FIG. 3) of the back end 130. The query 155 may be then provided to and processed by the agent 140. The result 160 of the execution of the query 155 can be provided to the computing device 110.

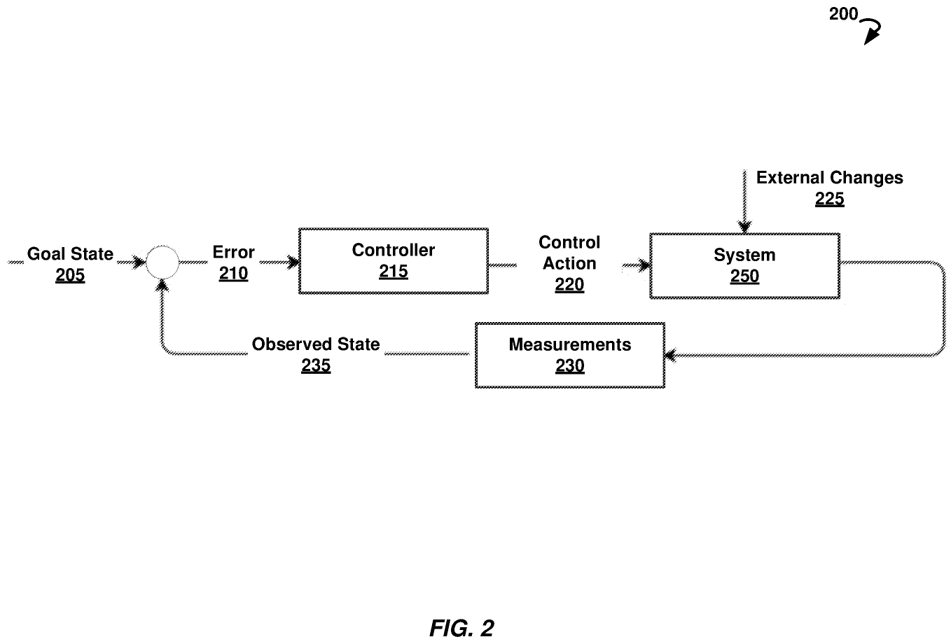

FIG. 2 is a schematic diagram 200 showing a process of measuring system performance and identifying errors, according to an example embodiment. Conventional processes for monitoring system performance typically involve a human operator. In particular, existing tools can be used to measure system performance and identify errors, but require a human operator to maintain control. However, manual decision is prone to introducing errors. Furthermore, there may be a considerable lag from when an issue is observed in a system under control to when a control action is taken.

As used herein, the system under control is a system of a customer that needs to be monitored and controlled. An example system under control may include an enterprise system, a system of a plurality of computing devices, a cloud system, a web-based system, a cloud-based system, and so forth. The methods and systems of the present disclosure provide an automated controller for monitoring system performance. In general, currently used approaches are more reactive than proactive, with control actions happening once a system is already impaired. Moreover, current actions are often taken per-instance rather than fleetwide (i.e., across a fleet of customer computers).

As shown in FIG. 3, a goal state 205 of the system under control shown as a system 250 can be monitored and an error 210 reported to a controller 215. The controller 215 may be responsible for taking a control action 220 to mitigate the error 210. Therefore, the control action 220 can be applied with respect to the system 250. In particular, external changes 225 can be applied to the system 250, for example, by changing parameters of the system 250. Upon taking the control action 220, measurements 230 associated with the system 250 can be determined, e.g., by measuring parameters of the system 250. Based on the measurements 230, an observer state 235 of the system 250 can be determined. The observed state 235 can be compared to the goal state 205 to determine whether any further errors exist and whether any further control actions are needed. Thus, the controller 215 can automatically respond to any errors in the goal state by taking control actions with no human operator being needed to maintain the control of the system 250.

FIG. 3 is a block diagram illustrating a back end module of the system for a fault-tolerant execution of command pipeline steps shown as a service provides data center 115 in FIG. 1. The back end module is shown as a back end 130. The back end 130 may include an authentication module 305, a planner 310, an execution module 315, a metadata database 320, and a metrics database 325. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

Each of the front end modules shown as front ends 125 in FIG. 1 can be configured to receive requests from a customer. A request may include one or more pipeline steps. For example, a request of the customer can include “list host|CPU|average” to compute an average processing performance of hosts. In an example embodiment, the front end 125 may include a network load balancer that receives the request. The back end 130 may have a plurality of back end nodes. The front end 125 can authenticate the customer that sends the request and performs a backend node mapping by checking a local cache to find customer information. If a corresponding entry with the customer information is present in the local cache, the front end 125 uses the corresponding back end node for routing the request. If an entry is not present, the front end 125 makes a request to the metadata database to fetch the backend node for the customer. The front end 125 can update its local cache with the customer information received from the metadata database. When the mapping is completed, the front end 125 can forward a message to the selected back end node of the back end 130. The message can include a front end identifier and a request, such that the front end 125 can receive results of the execution from the back end node later. The front end 125 may translate different interfaces/protocols into pipeline commands. For example, the request can come in from a command line interface or a website dashboard and then translated by the front end 125 into a common form, such as one or more pipeline commands, to be sent to the back end 130.

The back end 130 can receive the request and return a checkpoint number to identify the receipt of the request to the front end if the back end 130 determines that the customer is hosted by the back end node to which the request was sent by the front end. The back end 130 may use the authentication module 305 to authenticate the customer. In an example embodiment, the authentication of the customer may include identifying the customer and mapping the request to one or more back end nodes associated with the customer. The back end 130 may identify the customer based on customer information stored in the metadata database 320. The metrics database 325 may store metrics associated with the system under control of the customer. If the backend node does not host the customer, an error message can be returned to the front end. In this case, the front end may send a request to the metadata database to adjust the mapping of customer to the backend accordingly.

Upon receipt of the request, the back end 130 can start processing of the request, i.e. processing of the one or more pipeline commands received from the front end 125. The back end 130 reviews a local metadata database to determine a sequence number committed, i.e., the largest sequence number that is not for an outstanding request.

The back end 130 may further use the planner 310 to plan an execution of the request based on resources available to the customer. The planner 310 may be configured to ascertain resources available to the customer for the execution plan and create an execution plan for the request based on the one or more pipeline steps. The planner 310 may further translate the request into one or more flows for parallel execution on the available resources. During the planning, the largest sequence number for the request to be completed, i.e., the checkpoint sequence number (CSN) for the request, can be determined. The CSN can be then passed back to the front end. The back end 130 can locally store information as to which front end node was interested in the result of this CSN and use this information later to respond to the frontend node.

The back end 130 can be further configured to manage a plurality of agents associated with the resources including the agents that act as dispatchers. The plurality of the agents can be configured to run the one or more flows. Some of the plurality of agents can be in communication with the back end 130, such as agents 140 shown in FIG. 1. Therefore, the planner 130 can manage execution of the execution plan via the execution module 315 through agents installed on the plurality of resources. Each agent may have an execution module for executing the execution plan. The agents running on the resources may be in communication with each other. The back end 130 can be further configured to provide results of the execution to the customer by sending the results of the execution to the front end.

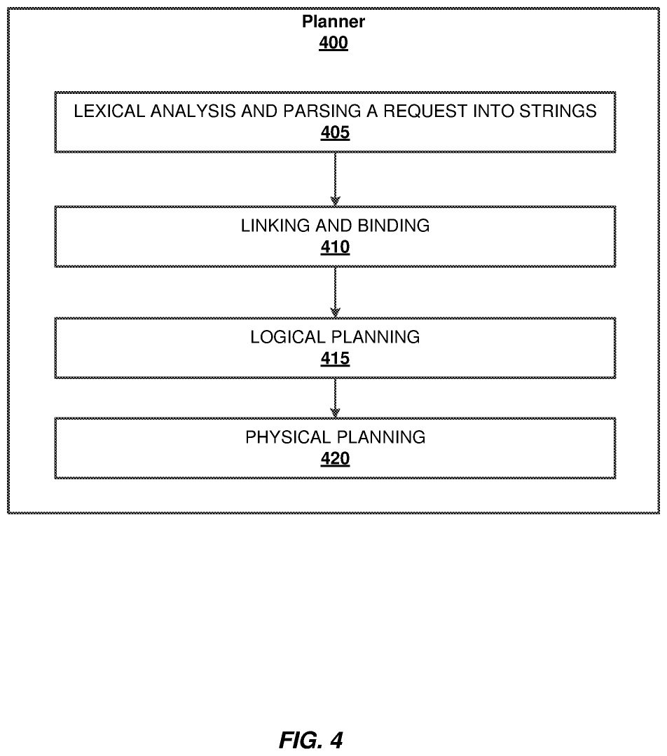

FIG. 4 shows a planner 310 and steps performed by the planner 310 to provide a fault-tolerant execution of command pipeline steps, according to an example embodiment. The planning may include preprocessing of the request, logical planning, and physical planning. Steps 405 and 410 may include static planning by performing preprocessing. The preprocessing may include step 405, at which lexical analysis of the request is performed by a lexical analyzer (also known as a lexer) by converting a string into a stream of tokens. Thereafter, the request can be parsed into one or more strings by a parser, which can convert the stream of tokens into an abstract syntax tree. At step 410, linking and binding of the one or more strings to function calls can performed, such that symbols can be linked to functions and a vice versa. The static planning can result in obtaining a statement that is well formed and symbols which are well defined.

At step 415, the logical planning of the execution plan for the request is performed. The logical planning can include transforming the statement into equivalent statements to maximize parallelism and minimize execution time. During the logical planning, a map can be created based on the linking of one or more string to function calls. The one or more strings can be transformed into equivalent statements for a parallel execution. The parallel execution can be optimized based on the resources. The output provided by the logical planning can include a graph of steps for the parallel execution. Symbols can be added to the graph, e.g., “sum,” “count,” and “div” (division).

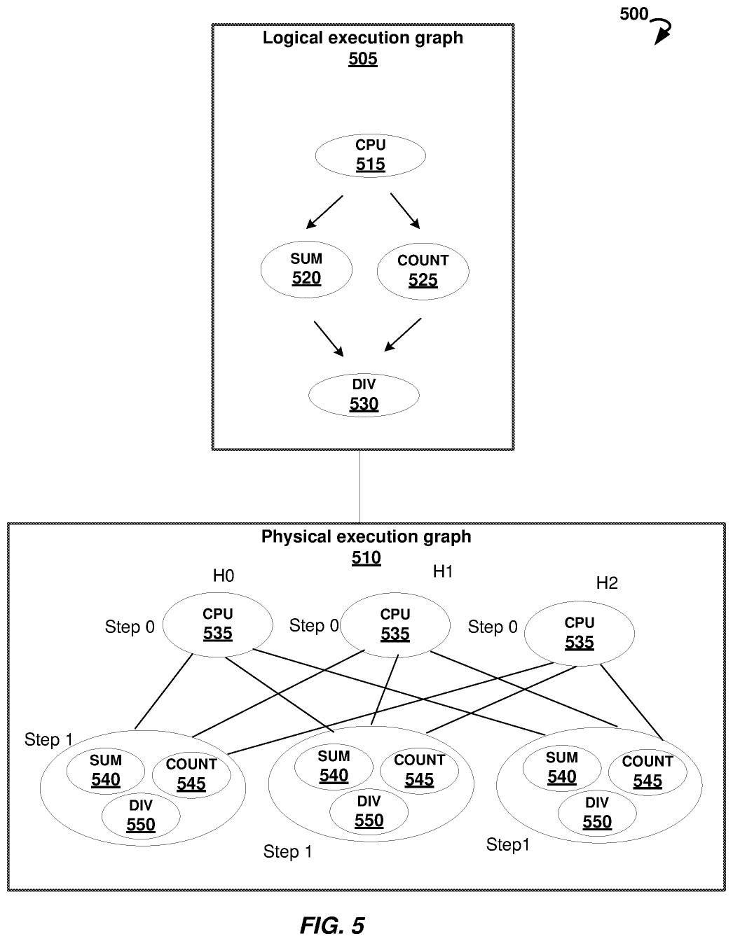

FIG. 5 shows a schematic diagram 500 illustrating a logical execution graph 505 and a physical execution graph 510. The logical execution graph 505 shows a central processing unit (CPU) 515 performing SUM 520 and COUNT 525 operations as well as performing a division (DIV) 530 operation.

After the logical planning is completed, a plan with a plurality of steps is provided, but the resulting plan is not executable because some of steps are abstract and have not been bound to physical hosts for execution yet. To resolve these issues, physical planning is necessary. Step 420 includes performing physical planning of the execution plan for the request. FIG. 5 illustrates an example physical execution graph 510, which includes a plurality of CPUs 535 performing SUM 540 and COUNT 545 operations as well as performing a DIV 550 operation to determine available resources. The physical planning can commence with determining available resources for physical execution of a logical execution plan. The logical execution plan may include steps for the parallel execution determined based on the logical planning. To this end, the back end repeatedly looks up the plan resulted from the logical planning, looks up steps that have their dependencies met and queries the local metadata database. The local metadata database then response to these requests (Step 0 in FIG. 5). These steps are context gathering steps at which calls to CPUs (hosts) are performed.

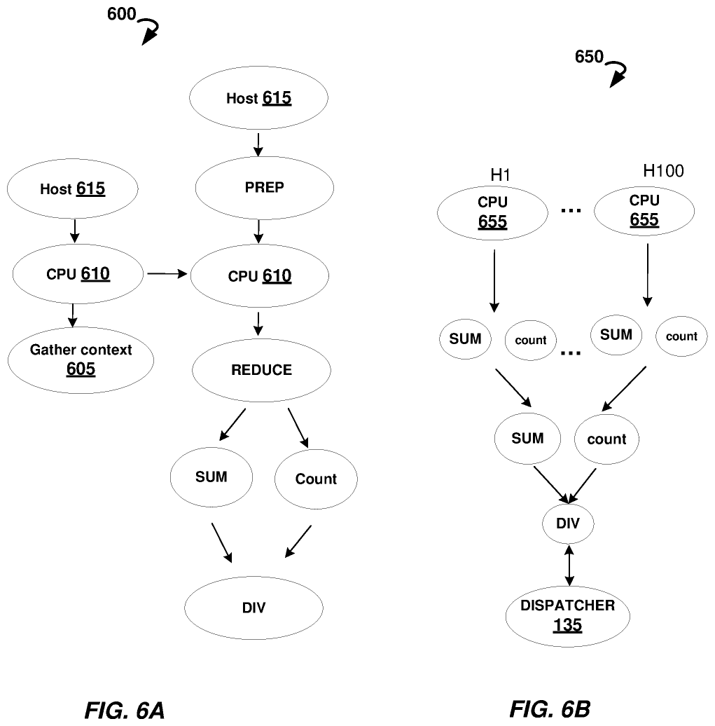

FIG. 6A shows steps 600 performed to gather context, according to an example embodiment. With the logical execution plan and the output of the context gathering 605 from CPUs 610 of hosts 615 (when each of CPUs 610 performs reduce, SUM, COUNT and DIV operations), the backend can make a call to the planner. The context gathering results and the logical execution plan can be passed to the planner. The planner can use the fact that it has 100 hosts and breaks up an average into SUM and COUNT so that the planner can parallelize the local call to CPUs and then leverage a tree to compute the average. First, all of the nodes can gather their current CPU utilization in parallel. Each CPU can perform SUM and COUNT operations and perform a DIV operation to determine available resources. The CPUs (e.g., 100 CPUs in total) can provide a return message to advertise that they are available for processing. See FIG. 6B showing steps 650 performed by each of CPUs 655, including SUM, COUNT, and DIV operations. Every 10 hosts can then forward their utilization to one host to compute SUBSUM and COUNT. Finally, the resultant 10 SUMS and COUNTS can be forwarded to a final host that takes a final SUM and COUNT and divides the SUM by COUNT to compute the average.

The physical planning step can also handle redundancy. Each SUM and COUNT can be duplicated three ways. Each host that gathers CPU data can send the message to three hosts. Each of these three hosts may perform SUM and COUNT operations. The intermediate SUMS and COUNTS may also send out their results three ways for final SUM, COUNT, and DIV.

To percolate back the result of the computation, the final result messages can be sent back to the dispatchers. Each dispatcher can, in turn, message the back end node with results. The back end node may wait for these results and then select a result to return to the front end.

The planner inspect all outstanding requests. No two mutating requests can be executed concurrently on the same hosts. To make sure this is true, the final plan of each request can be checked. It is checked if all operations are read only or if there is at least one operation that is read/write. If the plan has at least one read/write, this operation cannot be dispatched until the other read/write operation has completed. A record of all outstanding requests on the backend node can be kept to support the serialization of mutating requests. In some embodiments, the blocking of operations, so that only one write operation can proceed at a time, may be not optimal. Instead, multiple write requests can proceed concurrently so long as the multiple write requests operate on different resources.

Thus, based on the available resources and the logical execution plan, a physical execution plan can be created, for example, as a physical execution graph. Once the back end node has computed the physical execution plan, the physical execution plan needs to be issued to the agents. Thus, the physical execution plan can be issued to agents deployed on the plurality of resources associated with the customer. The physical execution plan can be designed for optimal parallel execution on the plurality of agents associated with the customer. The optimal parallel execution may include replicating the physical execution plan for executing the physical execution plan by each of the plurality of agents. However, only a subset of the agents acting as dispatchers can communicate directly with the backend node. With dispatchers 135, the number of hosts that need to be able to communicate, is significantly reduced. From a security perspective, this approach can reduce the attack surface, and from a networking perspective, this approach can limit the amount of extra configuration. To issue the physical execution plan, the back end node can send the physical execution plan to a predetermined number of dispatchers.

Thus, when the physical execution plan is complete, every step, all the nodes the plan must run on, step dependencies, and next hops of steps are known. The physical execution plan is sent to the dispatchers for execution the physical execution plan by the agents. The dispatchers now can issue all of the steps to the nodes (resources). A node can execute a step when all dependencies are met. Steps without dependencies (e.g., CPU) can be executed immediately. For steps with dependencies, the nodes can wait until the nodes have cached all of the dependent results before processing.

Once an issue step has been received, nodes can start waiting for timeouts on their dependencies. If a dependency times out, i.e., does not send a result before the timeout elapses, then the node is marked as timedout. Nodes that are marked as timedout can be removed from all downstream processing. To do this, timedout lists are passed with corresponding notifications. A step without a next hop is a terminal step. Completing execution of a terminal step can cause a notification to be sent to the back end.

As steps are completed, their results need to be sent to their next hops. To this end, nodes can make calls to each other and send notifying requests. The nodes can cache these results so that the nodes can execute their own steps once the dependencies are met.

The dispatchers can forward the final notification of the completion of the processing the request to the back end node. The back end node can update the CSN. The notification can be used to transmit the result more than once. Specifically, when performing the physical planning, the physical execution graph (e.g., in the form of a computation graph) may be replicated multiple ways such that the computation is performed redundantly, on different resources (e.g., different computers or cloud resources). This approach can allow tolerating the failure of a subset of the resources. Meanwhile, this approach may also introduce the issue of potentially having multiple results at the end of the computation. Hence, tie breaking may be needed. To break ties, in an example embodiment, the first result wins, i.e., is taken as a final result. The back end node may check the front end cache to determine if any front end nodes are waiting for the result. As indicated earlier, one of the front end nodes can be interested in the result. To inform the front end of the result, the back end node can make a call to the front end node and send the notification with the result to the front end node. The frontend node receives the result of the execution, looks up the processes waiting for the result locally, and send the result to the computing device of the customer.

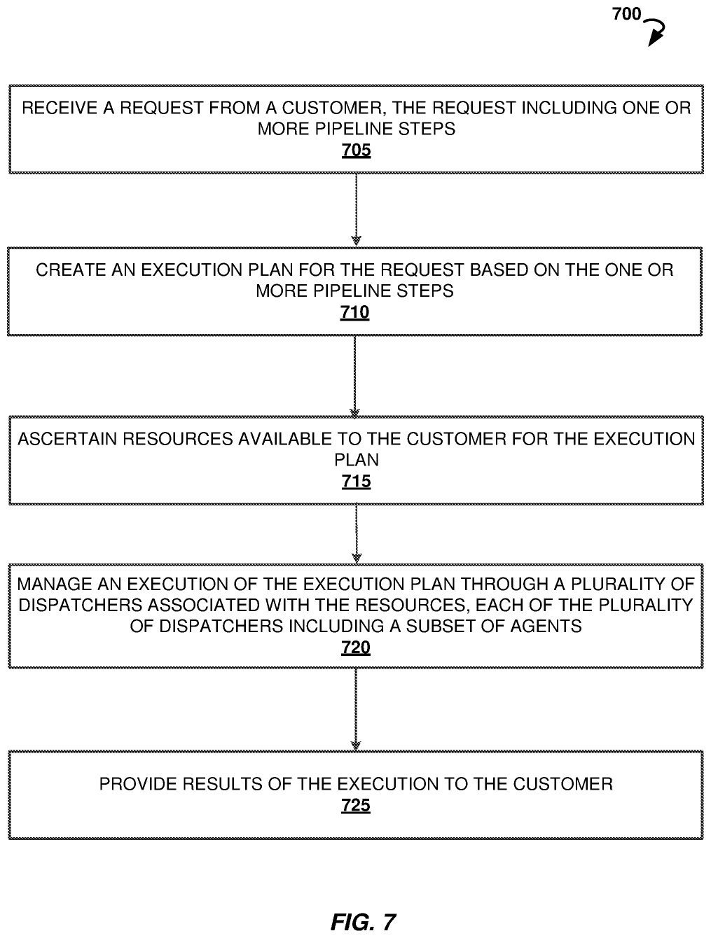

FIG. 7 is a flow chart showing a method 700 for a fault-tolerant execution of command pipeline steps, according to an example embodiment. The method 700 can commence with receiving a request from a customer. The request can include one or more pipeline steps at step 705. Optionally, the method 700 may include authentication of the customer. The authentication may include identifying the customer and mapping the request to one or more back end nodes associated with the customer. The method 700 may include maintaining a metadata database configured to store customer information. The authentication of the customer may be performed based on the customer information.

The method 700 may further include creating an executing a plan for the request based on the one or more pipeline steps at step 710. Creating the execution plan may include preprocessing, logical planning, and physical planning. The preprocessing may include performing lexical analysis of the request, parsing the request into one or more strings, and linking the one or more strings to function calls.

The logical planning may commence with creating a map based on the linking of one or more string to function calls. The one or more strings may be transformed into equivalent statements for parallel execution. The parallel execution can be optimized based on available resources. The output of the logical planning can include a graph of steps for parallel execution.

The physical planning may commence with determining available resources for physical execution of a logical execution plan. Based on the available resources and logical execution plan, a physical execution plan may be created. Then, the physical execution plan can be issued to agents running on the resources associated with the customer. The physical execution plan can be designed for optimal parallel execution on the plurality of resources associated with the customer. In an example embodiment, the request can be translated into one or more flows for parallel execution on the resources.

The method 700 can also include ascertaining resources available to the customer for the execution plan at step 715. The method 700 may also include managing execution of the execution plan through agents running on the resources, at step 720. The method 700 may further include managing the plurality of agents associated with the resources. The plurality of the agents can be configured to run as one or more flows. The plurality of agents can be managed by a back end module. The method 700 may then continue with providing results of the execution to the customer at step 725.

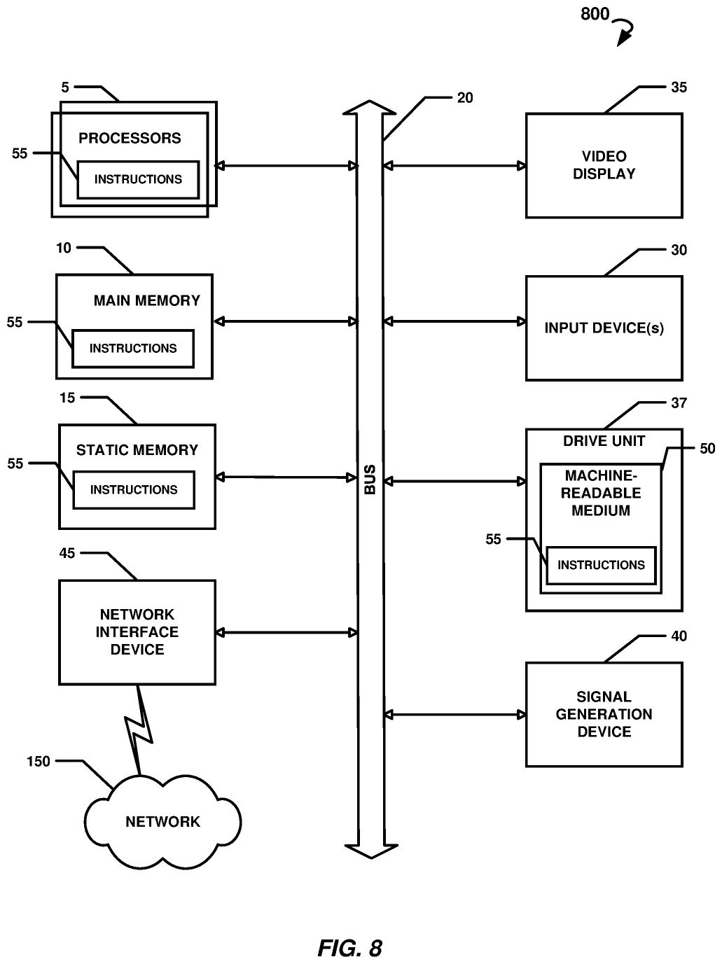

FIG. 8 is a diagrammatic representation of an example machine in the form of a computer system 810, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processor or multiple processor(s) 5 (e.g., a CPU, a graphics processing unit (GPU), or both), and a main memory 10 and static memory 15, which communicate with each other via a bus 20. The computer system 800 may further include a video display 35 (e.g., a liquid crystal display (LCD)). The computer system 800 may also include input device(s) 30 (also referred to as alpha-numeric input device(s), e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 800 may further include a data encryption module (not shown) to encrypt data.

The drive unit 37 includes a machine-readable medium 50 (which may be a computer readable medium) on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 800. The main memory 10 and the processor(s) 5 may also constitute machine-readable media.

The instructions 55 may further be transmitted or received over a network (e.g., network 150, see FIG. 1) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for a fault-tolerant execution of command pipeline steps, the method comprising:
receiving a request from a customer, the request including one or more pipeline steps;
creating an execution plan for the request based on the one or more pipeline steps;
ascertaining resources available to the customer for the execution plan;
managing an execution of the execution plan through agents associated with the resources; and
providing results of the execution to the customer.

2. The method of claim 1, wherein the planning includes:
preprocessing;
logical planning; and
physical planning.

3. The method of claim 2, wherein the preprocessing includes:
lexical analysis of the request;
parsing the request into one or more strings; and
linking the one or more strings to function calls.

4. The method of claim 2, wherein the logical planning includes:
creating a map based on the linking of one or more string to function calls;
transforming the one or more strings into equivalent statements for a parallel execution, the parallel execution being optimized based on the resources; and
outputting a graph of steps for the parallel execution.

5. The method of claim 2, wherein the physical planning includes:
determining available resources for physical execution of a logical execution plan;
based on the available resources and the logical execution plan, creating a physical execution plan; and
issuing the physical execution plan to the agents deployed on the plurality of resources associated with the customer, wherein the physical execution plan is designed for an optimal parallel execution on the agents associated with the customer, wherein the optimal parallel execution includes replicating the physical execution plan for executing the physical execution plan by one or more of the agents.

6. The method of claim 1, further comprising authenticating the customer, wherein the authentication of the customer includes:
identifying the customer; and
mapping the request to one or more back end nodes associated with the customer.

7. The method of claim 1, further comprising translating the request into one or more flows for parallel execution on the resources by the agents.

8. The method of claim 7, wherein a subset of the agents is configured to act as dispatchers, wherein the dispatchers are configured to communicate directly with a back end module.

9. The method of claim 8, wherein the dispatchers are managed by a back end module.

10. The method of claim 1, further comprising maintaining a metadata database configured to store customer information.

11. A system for a fault-tolerant execution of command pipeline steps, the system including:
a front end module configured to:
receive a request from a customer, the request including one or more pipeline steps;
a back end module configured to:
process the request;
authenticate the customer;
plan an execution of the request based on resources available to the customer;
translate the request into one or more flows for parallel execution on the resources;
manage agents associated with the resources, the agents being configured to run the one or more flows; and
provide results of the execution to the customer.

12. The system of claim 11, wherein the front end module is further configured to translate the request into one or more pipeline commands, wherein the processing of the request by the back end module includes processing the one or more pipeline commands.

13. The system of claim 11, wherein the authentication of the customer includes:
identifying the customer; and
mapping the request to one or more back end nodes associated with the customer.

14. The system of claim 11, wherein the back end module further comprises a metadata database configured to store customer information.

15. The system of claim 11, wherein the front end module includes a network load balancer.

16. The system of claim 11, wherein the planning includes:
preprocessing;
logical planning; and
physical planning.

17. The system of claim 16, wherein the preprocessing includes:
lexical analysis of the request;
parsing the request into one or more strings; and
linking the one or more strings to function calls.

18. The system of claim 16, wherein the logical planning includes:
creating a map based on the linking of one or more string to function calls;
transforming the one or more strings into equivalent statements for a parallel execution, the parallel execution being optimized based on the resources; and
outputting a graph of steps for the parallel execution.

19. The system of claim 16, wherein the physical planning includes:
determining available resources for physical execution of a logical execution plan;
based on the available resources and the logical execution plan, creating a physical execution plan; and
issuing the physical execution plan to the agents deployed on the plurality of resources associated with the customer, wherein the physical execution plan is designed for an optimal parallel execution on the agents associated with the customer and wherein the optimal parallel execution includes replicating the physical execution plan for executing the physical execution plan by each of the agents.

20. A system for a fault-tolerant execution of command pipeline steps, the system including:
a front end module configured to:
receive a request from a customer, the request including one or more pipeline steps;
a back end module configured to:
process the request;
authenticate the customer;
plan an execution of the request based on resources available to the customer, wherein the planning includes:
preprocessing including:
lexical analysis of the request;
parsing the request into one or more strings; and
linking the one or more strings to function calls;
logical planning including:
creating a map based on the linking of one or more string to function calls;
transforming the one or more strings into equivalent statements for a parallel execution, the parallel execution being optimized based on the resources; and
outputting a graph of steps for the parallel execution; and
physical planning including:
determining available resources for physical execution of a logical execution plan;
based on the available resources and the logical execution plan, creating a physical execution plan; and
issuing the physical execution plan to agents deployed on the plurality of resources associated with the customer, wherein the physical execution plan is designed for an optimal parallel execution on the agents associated with the customer, wherein the optimal parallel execution includes replicating the physical execution plan for executing the physical execution plan by one or more of the agents;
translate the request into one or more flows for parallel execution on the resources;
manage the agents associated with the resources, the agents being configured to run the one or more flows; and
provide results of the execution to the customer.
